(19) United States
(12) Patent Application Publication
(10) Pub. No.: US 2015/0085755 A1
(43) Pub. Date: Mar. 26, 2015

(54) COORDINATED DETERMINATION OF PHYSICAL LAYER IDENTIFIER AND TRANSMIT POWER

(71) Applicant: QUALCOMM Incorporated, San Diego, CA (US)

(72) Inventors: Damanjit SINGH, San Diego, CA (US); Christophe CHEVALLIER, San Diego, CA (US)

(73) Assignee: QUALCOMM Incorporated, San Diego, CA (US)

(21) Appl. No.: 14/034,277

(22) Filed: Sep. 23, 2013

(51) Int. Cl. H04W 52/54

(52) U.S. Cl. CPC H04W 52/54
USPC 370/329

(57) ABSTRACT

The assignment of physical layer identifiers for access points is coordinated with the assignment of transmit powers for the access points. For example, only those access points that transmit at a relatively high power level are allowed to use a physical layer identifier from a subset of physical layer identifiers allocated for mobility measurements. Any other access points will use a physical layer identifier that is not allocated for mobility measurements. By restricting the number of access points that are allowed to use a physical layer identifier allocated for mobility measurements, confusion and collision in the network may be mitigated.

### BACKGROUND

This application relates generally to wireless communication and more specifically, but not exclusively, to determining a physical layer identifier and transmit power for an access point.

A wireless communication network may be deployed to provide various types of services (e.g., voice, data, multimedia services, etc.) to users within a coverage area of the network. In some implementations, macro access points (e.g., corresponding to different macro cells) are distributed throughout a geographical area to provide wireless connectivity for access terminals (e.g., cell phones) that are operating within the area. In addition, core network entities support connectivity between access points, access to other networks (e.g., the Internet), management functions, and other related functions.

Each access point (or cell) in a network may be assigned a physical layer identifier that is used to identify the access point (cell), at least on a local basis. For example, a physical layer identifier may comprise a primary scrambling code (PSC) in UMTS or a physical cell identifier (PCI) in LTE. Other types of physical layer identifiers may be used in other technologies.

Each access point broadcasts a reference signal (e.g., a pilot signal or beacon signal) that comprises the physical layer identifier. For example, a given reference signal may be encoded based on a corresponding physical layer identifier.

Consequently, any receivers in a given area may acquire the reference signals broadcast by the access points in the area to learn the identity of the access points in the area, as well as certain system parameters used by those access points. In particular, access terminals (and, optionally, access points that have network listen capability) may learn the physical layer identifiers of neighboring access points to facilitate hand-off of access terminals between access points.

Typically, a fixed quantity of physical layer identifiers (e.g., 512 physical layer identifiers) is defined in a given network. Accordingly, in conventional network planning, a network operator carefully assigns physical layer identifiers to access points to avoid so-called collisions or confusion between the physical layer identifiers used by different access points.

For example, if two or more access points within communications range of an access terminal use the same physical layer identifier, the access terminal may not be able to decode the signals since the signals are based on the same physical layer identifier. This situation is known as physical layer identifier collision. Such collisions may result in significant interference on a channel, thereby causing potential service disruptions.

In addition, if two or more access points broadcast the same physical layer identifier, these access points may not be distinguishable for purposes of access terminal handover. This situation is known as physical layer identifier confusion. Such confusion may result in handover failure, thereby causing potential service disruptions.

Furthermore, the number of physical layer identifiers used for mobility measurements may be limited. For example, in UMTS, only 32 out of 512 available primary scrambling codes (PSCs) may be available for mobility measurements. In a network that uses small cells (e.g., femto cells, Home NodeBs, etc.), the number of small cells in a given region may exceed the number of available physical layer identifiers. Consequently, physical layer identifier collisions or confusion may occur in such a network.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to coordinating the assignment of physical layer identifiers for access points (e.g., small cells) with the assignment of transmit power for the access points. For example, only those small cells that transmit at a relatively high power level may be allowed to use one of the physical layer identifiers allocated for mobility measurements (e.g., the 32 PSCs in UMTS). Any small cells that transmit at a relatively low power level must use one of the physical layer identifiers not allocated for mobility measurements (e.g., the remaining 480 PSCs in UMTS). Since most handovers from a macro cell to a small cell are directed to small cells that provide outdoor coverage (and, hence, have higher transmit power), a target small cell will most likely be using one of the physical layer identifiers allocated for mobility measurements in a system constructed in accordance with the application. Thus, collision and confusion are less likely to occur in such a system.

The disclosure relates in some aspects to selecting a physical layer identifier for an access point based on the transmit power of the access point. For example, upon determining that an access point transmits at a relatively high power level (e.g., sufficient to provide outdoor coverage), the access point is assigned one of the physical layer identifiers allocated for mobility measurements. The access point then transmits a reference signal (e.g., a pilot signal) comprising the assigned physical layer identifier. As this physical layer identifier is less likely to be subject to collision and confusion, the access point may be readily identified by nearby access terminals as a potential handover target.

The disclosure relates in some aspects to determining the transmit power of an access point based on the physical layer identifier used by the access point. For example, an entity (e.g., a neighbor of the access point, an access terminal, etc.) may identify the physical layer identifier used by the access point. Based on this physical layer identifier, the entity can determine (e.g., estimate) the transmit power used by the access point. For example, the entity may determine whether the access point will transmit at a high power level or a low power level. The entity may then take appropriate action (e.g., select a transmit power and/or mobility parameters for one or more access points) based on the determined transmit power of the access point.

The disclosure relates in some aspects to determining the transmit power for an access point based on the physical layer identifier selected for the access point. For example, a physical layer identifier may be selected for an access point (e.g., the access point may select its own physical layer identifier). Then, based on this physical layer identifier, a determination may be made as at to what transmit power the access point should use. For example, a determination may be made as to whether the access point will transmit at a high power level or a low power level depending on whether the access point uses a physical layer identifier that is allocated for mobility measurements.

The teachings herein may be embodied and/or practiced in different ways in different implementations.

In some aspects, an apparatus for communication in accordance with the teachings herein comprises: a processing system configured to determine a transmit power of an access point, and determine a physical layer identifier for the access point based on the determined transmit power; and a communication device configured to send a signal comprising the determined physical layer identifier.

In some aspects, a method of communication in accordance with the teachings herein comprises: determining a transmit power of an access point; determining a physical layer identifier for the access point based on the determined transmit power; and sending a signal comprising the determined physical layer identifier.

In some aspects, an apparatus for communication in accordance with the teachings herein comprises: means for determining a transmit power of an access point; means for determining a physical layer identifier for the access point based on the determined transmit power; and means for sending a signal comprising the determined physical layer identifier.

In some aspects, a computer-program product in accordance with the teachings herein comprises computer-readable medium comprising code for causing a computer to: determine a transmit power of an access point; determine a physical layer identifier for the access point based on the determined transmit power; and send a signal comprising the determined physical layer identifier.

In some aspects, an apparatus for communication in accordance with the teachings herein comprises: a communication device configured to receive a signal; and a processing system configured to determine a physical layer identifier of an access point based on the received signal, determine a transmit power of the access point based on the determined physical layer identifier, and invoke an action based on the determined transmit power.

In some aspects, a method of communication in accordance with the teachings herein comprises: receiving a signal; determining a physical layer identifier of an access point based on the received signal; determining a transmit power of the access point based on the determined physical layer identifier; and invoking an action based on the determined transmit power.

In some aspects, an apparatus for communication in accordance with the teachings herein comprises: means for receiving a signal; means for determining a physical layer identifier of an access point based on the received signal; means for determining a transmit power of the access point based on the determined physical layer identifier; and means for invoking an action based on the determined transmit power.

In some aspects, a computer-program product in accordance with the teachings herein comprises computer-readable medium comprising code for causing a computer to: receive a signal; determine a physical layer identifier of an access point based on the received signal; determine a transmit power of the access point based on the determined physical layer identifier; and invoke an action based on the determined transmit power.

In some aspects, an apparatus for communication in accordance with the teachings herein comprises: a processing system configured to determine a physical layer identifier for an access point, and determine a transmit power for the access point based on the determined physical layer identifier; and a communication device configured to send a signal based on the determined transmit power.

In some aspects, a method of communication in accordance with the teachings herein comprises: determining a physical layer identifier for an access point; determining a transmit power for the access point based on the determined physical layer identifier; and sending a signal based on the determined transmit power.

In some aspects, an apparatus for communication in accordance with the teachings herein comprises: means for determining a physical layer identifier for an access point; means for determining a transmit power for the access point based on the determined physical layer identifier; and means for sending a signal based on the determined transmit power.

In some aspects, a computer-program product in accordance with the teachings herein comprises computer-readable medium comprising code for causing a computer to: determine a physical layer identifier for an access point; determine a transmit power for the access point based on the determined physical layer identifier; and send a signal based on the determined transmit power.

### BRIEF DESCRIPTION OF THE DRAWINGS

These and other sample aspects of the disclosure will be described in the detailed description and the claims that follow, and in the accompanying drawings, wherein:

FIG. 1 is a simplified diagram illustrating an example of physical layer identifier allocation;

FIG. 2 is a simplified block diagram of several sample aspects of a communication system adapted to support coordinated determination of physical layer identifiers and transmit power;

FIG. 3 is a flowchart of several sample aspects of operations that may be performed in conjunction with determining a physical layer identifier based on transmit power;

FIG. 4 is flowchart of several sample aspects of operations that may be performed in conjunction with determining transmit power based on a physical layer identifier;

FIG. 5 is flowchart of several sample aspects of other operations that may be performed in conjunction with determining transmit power based on a physical layer identifier;

FIG. 6 is a simplified block diagram of several sample aspects of components that may be employed in communication nodes;

FIG. 7 is a simplified diagram of a wireless communication system;

FIG. 8 is a simplified diagram of a wireless communication system including small cells;

FIG. 9 is a simplified diagram illustrating coverage areas for wireless communication;

FIG. 10 is a simplified block diagram of several sample aspects of communication components; and

FIGS. 11-13 are simplified block diagrams of several sample aspects of apparatuses configured to support coordinated determination of physical layer identifiers and transmit power as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

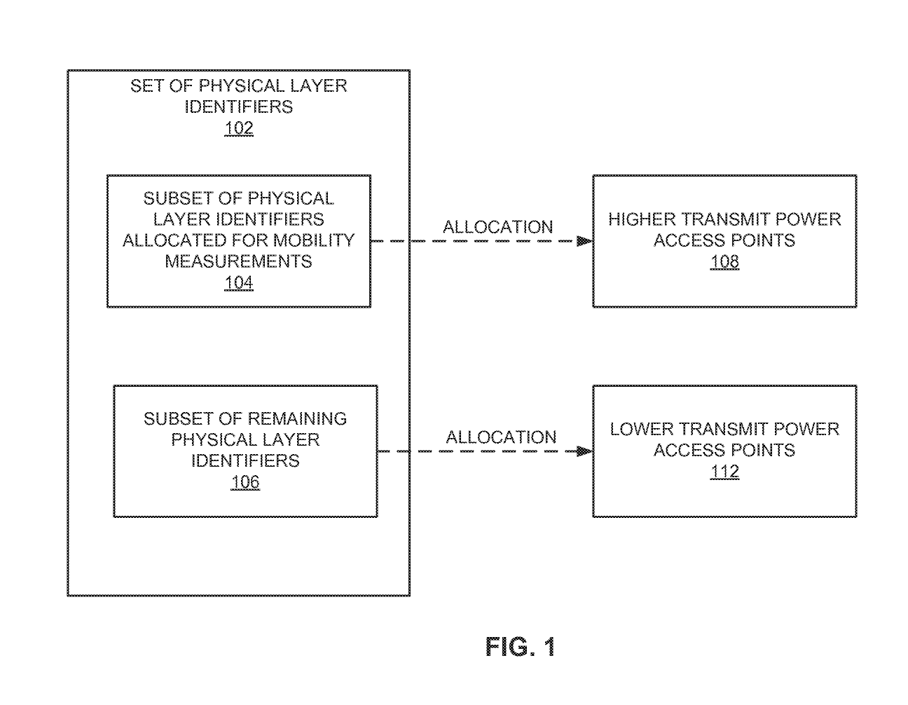

The disclosure relates in some aspects to coordinating the allocation of physical layer identifiers and transmit power for access points. As illustrated in FIG. 1, within a set of physical layer identifiers 102 defined for a network, two subsets are defined: a subset of physical layer identifiers allocated for mobility measurement 104 and a subset of remaining physical layer identifiers 106 (i.e., the physical layer identifiers not allocated for mobility measurement). The subset 104 consists of those physical layer identifiers that an access terminal in the network may use when conducting measurements for potential target access points (e.g., small cells such as femto cells, Home NodeBs, etc.). In other words, an access terminal will look for access points that use the physical layer identifiers of subset 104, but will not look for access points that use the physical layer identifiers of subset 106.

As further illustrated in FIG. 1, physical layer identifiers of the subset 104 are only allocated to higher transmit power access points 108. Lower power access points 112 are allocated physical layer identifiers from the subset 106. By restricting the number of access points that are allowed to use physical layer identifiers of the subset 104, fewer physical layer identifier collisions or less physical layer identifier confusion will be seen with these physical layer identifiers. Of note, handovers (e.g., from a macro cell) will most likely be made to a higher transmit power access point (having a larger coverage area) rather than to a lower transmit power access point. Due to the use of the physical layer identifiers from the subset 104 by these higher transmit power access points, fewer collisions and less confusion can be expected in the network.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim.

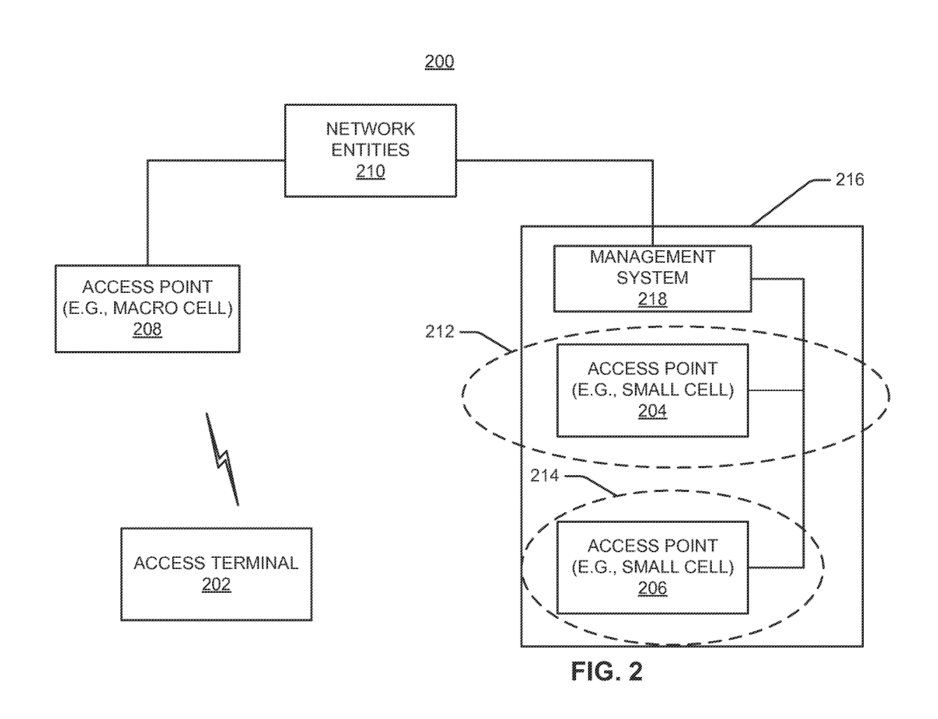

FIG. 2 illustrates several nodes of a sample communication system 200 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points in the system 200 provide access to one or more services (e.g., network connectivity) for one or more wireless terminals (e.g., access terminal 202) that may be installed within or that may roam throughout a coverage area of the system 200. For example, at various points in time the access terminal 202 may connect to an access point 204, an access point 206, an access point 208, or some other access point in the system 200 (not shown).

Each of the access points may communicate with one or more network entities (represented, for convenience, by the network entities 210), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 210 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

Some of the access points (e.g., the access point 112) in the system 100 may comprise low-power access points (or low-power cells). Various types of low-power access points may be employed in a given system. For example, low-power access points may be implemented as or referred to as femto cells, femto access points, small cells, femto nodes, home NodeBs (HNBs), home eNodeBs (HeNBs), access point base stations, pico cells, pico nodes, or micro cells. Typically, low-power access points connect to the Internet via a broadband connection (e.g., a digital subscriber line (DSL) router, a cable modem, or some other type of modem) that provides a backhaul link to a mobile operator's network. Thus, a low-power access point deployed in a user's home or business provides mobile network access to one or more devices via the broadband connection.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femto cells may have a maximum transmit power of 20 dBm or less. In some implementations, low-power access points such as pico cells may have a maximum transmit power of 24 dBm or less. It should be appreciated, however, that these or other types of low-power access points may have a higher or lower maximum transmit power in other implementations (e.g., up to 1 Watt in some cases, up to 10 Watts in some cases, and so on).

For convenience, low-power access points may be referred to simply as small cells in the discussion that follows. Thus, it should be appreciated that any discussion related to small cells herein may be equally applicable to low-power access points in general (e.g., to femto cells, to micro cells, to pico cells, etc.).

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

As mentioned above, the access terminal 202 may be served by a given one of the access points of the system 200. As the access terminal moves throughout the coverage area of the system 200, the access terminal 202 may move away from its serving access point and move closer to another access point. In addition, signal conditions within a given cell may change, whereby the access terminal 202 may be better served by another access point. In either of these cases, to maintain mobility for the access terminal 202, the access terminal 202 may be handed-over from its serving access point to the other access point.

In a system that has a high density of small cells, there is a relatively high probability that two or more neighboring cells may select or be assigned the same physical layer identifier. Consequently, there is a possibility of physical layer identifier collision or physical layer identifier confusion in such a system. Both idle-mode mobility (i.e., cell reselections) and connected-mode mobility (i.e., handovers) may be affected in this manner.

Collision or confusion is particularly likely in a system that limits the number of physical layer identifiers that are available for mobility measurements. For example, in UMTS, 32 PSCs are available for inter-frequency mobility measurements. Thus, in a system that employs a large number of small cells (e.g., much greater than 32) on a dedicated carrier within the coverage of a given macro cell, hand-in from a macro cell to a small cell may be subject to confusion and collisions. For example, to enable macro-to-small cell mobility, a small cell would need to use one of the 32 PSCs so that the small cell can be advertised within the macro network (e.g., as a result of access terminal measurement reports). Given that the number of small cells operating within the coverage of the macro cell is much greater than 32 in this example, collision, confusion, and other service and mobility issues are likely.

In accordance with the teachings herein, only a limited number of access points (e.g., small cells) within a given area are allowed to use the physical layer identifiers allocated for mobility measurements (e.g., the 32 PSCs). The remaining access points within the area can use the remaining physical layer identifiers (e.g., the remaining 480 PSCs).

In some implementations, to maximize macro-to-small cell offload, only those small cells with a relatively high transmit power are allowed to use the physical layer identifiers allocated for mobility measurements. In this way, hand-in may be made to those small cells that provide the largest coverage areas, while mitigating collision and confusion in the system.

In the example of FIG. 2, the access point 206 transmits at a relatively low power level such that the corresponding coverage area 214 is largely limited to within a building 216. In contrast, the access point 204 transmits at a relatively high power level as indicated by the coverage area 212 extending outside of the building 216. It is desirable, and more likely, that hand-in of the access terminal 202 from the access point 208 (e.g., a macro cell) will be to the access point 204. Thus, in a high density scenario, it is preferred that the access point 204 be allowed to use one of the physical layer identifiers allocated for mobility measurements, while the access point 206 is not allowed to use such a physical layer identifier.

An access point may be configured in various ways consistent with the teachings herein. For example, an access point may select its own physical layer identifier and/or transmit power, or another entity may select a physical layer identifier and/or transmit power for the access point.

In a case where an access point selects its own physical layer identifier and/or transmit power, the access point is provisioned with (or otherwise has access to) the set of physical layer identifiers that may be used in the network. For example, the access point 204 may obtain this physical layer identifier information from a management system 218 (e.g., a Home NodeB management system) or from some other entity (e.g., the network entities 210). The physical layer identifier information will indicate which physical layer identifiers are allocated for mobility measurements.

As discussed in more detail below, the access point may either select its physical layer identifier based on the access point's designated transmit power or select its transmit power based on the access point's designated physical layer identifier. In either case, the selection may be made such that the access point uses a physical layer identifier allocated for mobility measurements only if the access point has a relatively high transmit power.

A similar selection is made in the case where another entity (e.g., the management system 218 or the network entities 210) selects a physical layer identifier for an access point. That is, the entity may select the physical layer identifier and/or the transmit power such that the access point uses a physical layer identifier allocated for mobility measurements if the access point has a relatively high transmit power.

Advantageously, in a system employing the teachings herein, an entity may be able to estimate the transmit power of an access point based on the physical layer identifier used by the access point. For example, if it is determined that an access point uses a physical layer identifier allocated for mobility measurements, it may be assumed that the access point transmits at a relatively high power level. Conversely, if it is determined that an access point uses a physical layer identifier that is not allocated for mobility measurements, it may be assumed that the access point transmits at a relatively low power level.

Consequently, the entity (e.g., a neighboring access point or an access terminal) may be able to estimate this transmit power with having to acquire transmit power information from the access point. For example, an estimate of the transmit power may be obtained without having to read the system information blocks (SIBs) broadcast by the access point or without having a direct communication link (e.g., X2 or lur) with the access point.

Knowledge of such a transmit power estimate may be used for various purposes. For example, knowledge of the transmit power of one access point may be used to determine (e.g., set or adapt) the transmit power for another access point (e.g., a neighbor access point). As another example, knowledge of the transmit power of one access point may be used to determine (e.g., set or adapt) mobility decisions and/or mobility configurations for another access point (e.g., a neighbor access point).

Accordingly, the coordinating the selection of the physical layer identifiers and transmit power of access points may lead to improvements in mobility management and service in a network. For example, physical layer identifier confusion and collision may be mitigated. Neighbor list management may be improved since signal inter-frequency neighbor lists or intra-frequency neighbor lists may be configured using the disclosed physical layer identifier selection techniques. Furthermore, more effective offloading of users from a macro cell to a small cell may be achieved, particularly when the macro cell and the small cells are deployed on a separate frequency or layer.

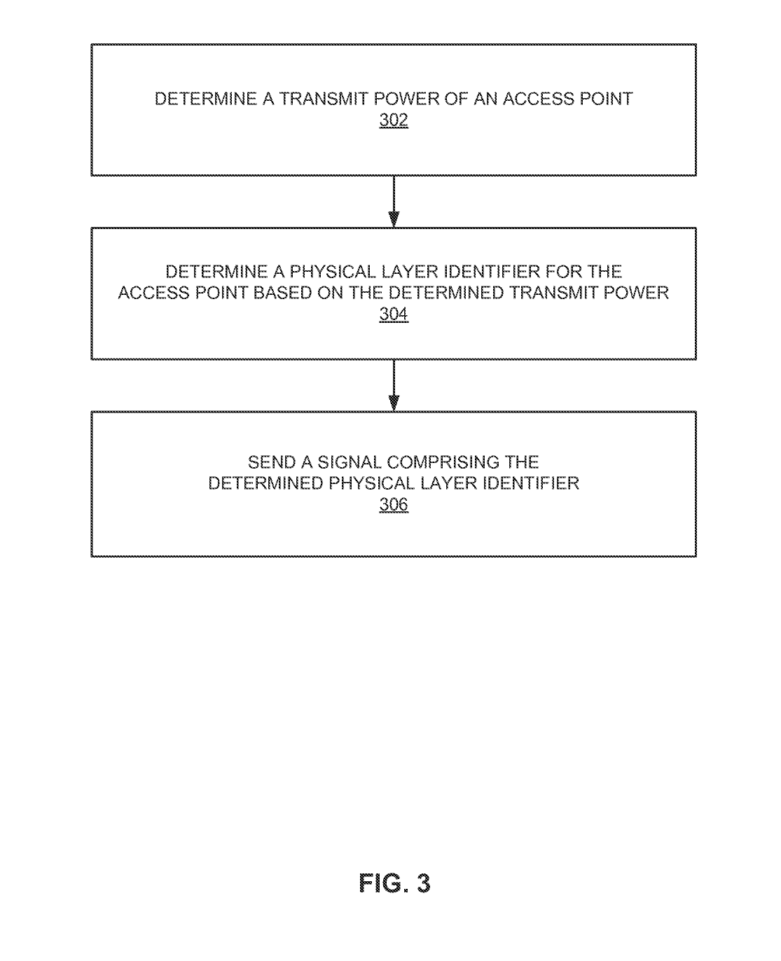

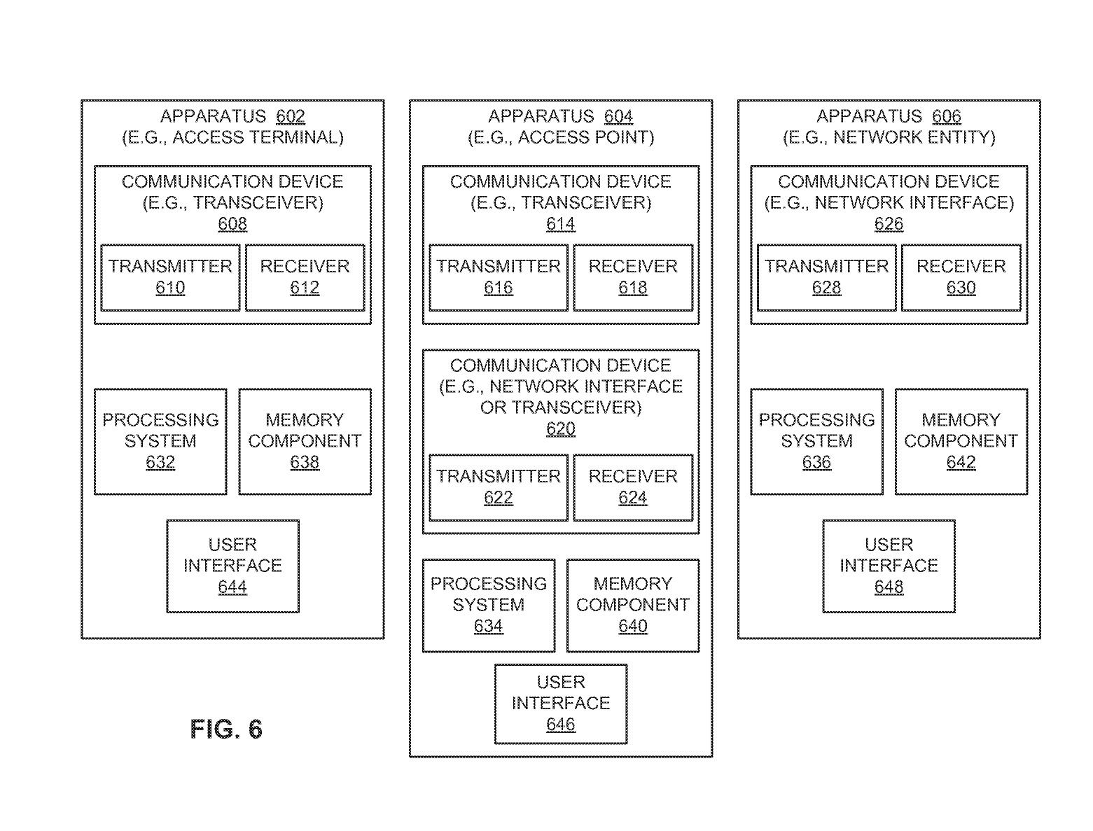

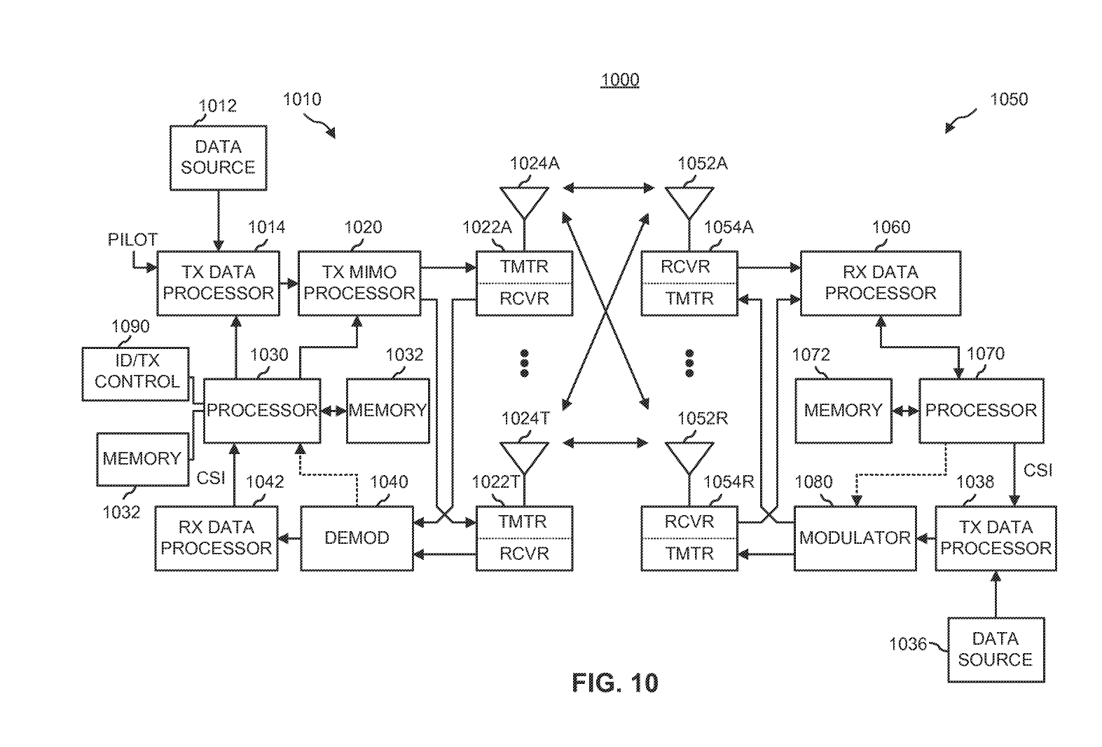

Sample operations relating to determination of physical layer identifiers and transmit power will now be described in more detail in conjunction with the flowcharts of FIGS. 3, 4, and 5. For convenience, the operations of FIGS. 3, 4, and 5 (or any other operations discussed or taught herein) may be described as being performed by specific components (e.g., components of FIG. 1, FIG. 2, FIG. 6, or FIGS. 10-13). It should be appreciated, however, that these operations may be performed by other types of components and may be performed using a different number of components. It also should be appreciated that one or more of the operations described herein may not be employed in a given implementation.

FIG. 3 illustrates an example of operations that may be performed in conjunction with determining a physical layer identifier based on transmit power. For example, the physical layer identifier to be used by an access point may be selected based on the transmit power being used by (or otherwise allocated for) the access point. The operations of FIG. 3 may be performed by an access point, a network entity, or some other suitable entity or entities.

As represented by block 302, as some point in time, the transmit power of an access point is determined. This determination may involve, for example, selecting the transmit power to be used by the access point, receiving an indication of the transmit power to be used by the access point, negotiating with another entity to agree upon a transmit power to be used by the access point, and so on.

The transmit power to be used by a given small cell may be determined based on the transmit power used by any surrounding cells. For example, upon determining that there are relatively few nearby small cells or that the nearby small cells transmit at a relatively low power level, a relatively high transmit power may be selected for a new small to provide more small cell coverage in that area. Conversely, upon determining that the nearby small cells transmit at a relatively high power level, a relatively low transmit power may be selected for a new small to avoid interfering with the existing cells.

In some scenarios, the determination of the transmit power for a given access point may be dynamic in nature. For example, the transmit power used by a given small cell may be adjusted as small cells are added to or removed from the area. Also, the transmit power used by a given small cell may be adjusted as neighboring small cells adjust their transmit power.

The transmit power to be used by a given small cell may be determined based on the bandwidth or capacity of the small cell. For example, a relatively high transmit power may be selected for a small cell that has high backhaul bandwidth or a large amount of radio resources. In this way, the small cell can potentially provide service for more access terminals since the small cell will provide coverage over a wider area.

As represented by block 304, a physical layer identifier for the access point is determined based on the transmit power determined at block 302. For example, as discussed herein, certain physical layer identifiers may be selected depending on whether the transmit power is relatively high or relatively low.

Different criteria may be employed in different implementations to determine whether an access point has a high transmit power or a low transmit power.

In some implementations, the transmit power is compared to one or more thresholds. In this case, a transmit power higher than a particular threshold may be deemed to be a high transmit power. Accordingly, in some aspects, the determination of the physical layer identifier may comprise: comparing the determined transmit power to a threshold, and selecting a physical layer identifier from a set of physical layer identifiers based on the comparison.

In some implementations, the transmit power is compared to the transmit power being used by other access points (e.g., in a given area). In this case, the access points with the highest transmit power of the set may be deemed to be transmitting at a high transmit power. Here, the highest transmit power may be determined based on a percentage (e.g., the highest 10%), a defined quantity (e.g., the highest 20 transmit powers), some other factor, or a combination of these factors.

As discussed herein, a set of physical layer identifiers used by a network may comprise a first subset of physical layer identifiers that are allocated for mobility measurements and a second subset of physical layer identifiers that are not allocated for mobility measurements. Accordingly, in some aspects, the determination of the physical layer identifier may comprise determining whether to select the physical layer identifier for the access point from the first subset of physical layer identifiers or the second subset of physical layer identifiers.

Similarly, a set of physical layer identifiers used by a network may comprise a first subset of physical layer identifiers associated with a high transmit power and a second subset of physical layer identifiers associated with a low transmit power. Accordingly, in some aspects, the determination of the physical layer identifier may comprise determining whether to select the physical layer identifier for the access point from the first subset of physical layer identifiers or the second subset of physical layer identifiers. Also, in some aspects, the determination of the physical layer identifier may comprise: determining whether the transmit power of the access point corresponds to the high transmit power or the low transmit power; and determining, based on the determination of whether the transmit power of the access point corresponds to the high transmit power or the low transmit power, whether to select the physical layer identifier for the access point from the first subset of physical layer identifiers or the second subset of physical layer identifiers.

As represented by block 306, a signal comprising the physical layer identifier determined at block 304 is sent. The form of this signal and the manner in which the signal is sent may depend, in some aspects, on the particular entity that is performing the operations of FIG. 3.

In an implementation where the access point performs the operations of FIG. 3 (e.g., the access point determines its own physical layer identifier), the sending of the signal at block 306 may involve, for example, broadcasting a reference signal that comprises (e.g., is encoded using) the determined physical layer identifier. Accordingly, in some aspects, the sending of the signal may comprise transmitting a signal that is encoded based on the determined physical layer identifier.

In an implementation where another entity performs the operations of FIG. 3 (e.g., a network entity determines the access point's physical layer identifier), the sending of the signal at block 306 may involve, for example, sending an indication of the physical layer identifier to the access point. Accordingly, in some aspects, the sending of the signal may comprise sending the determined physical layer identifier to the access point.

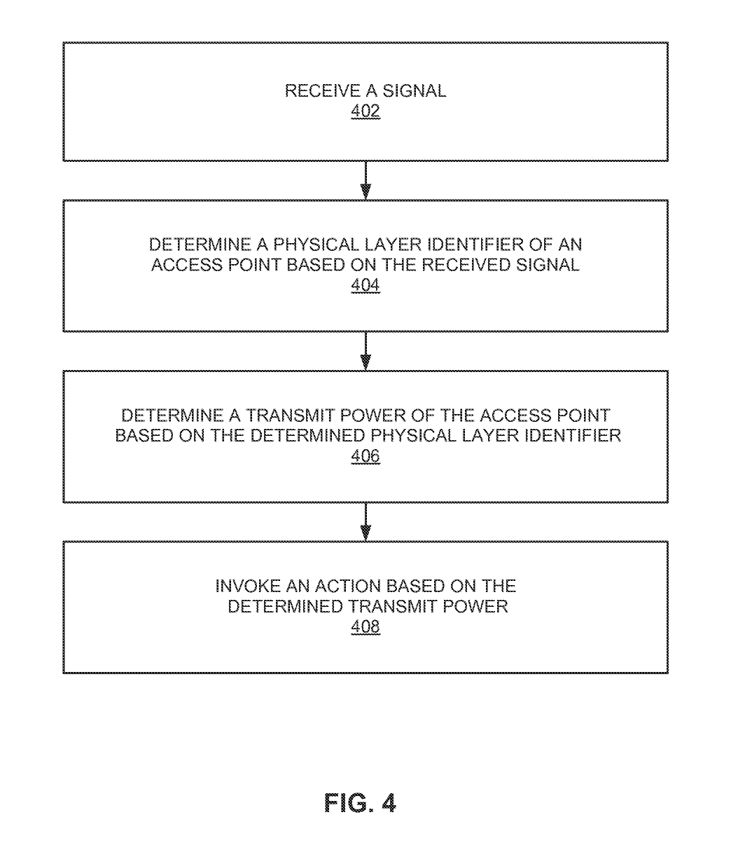

FIG. 4 illustrates an example of operations that may be performed in conjunction with determining (e.g., estimating) the transmit power of an access point based on a physical layer identifier associated with the access point. For example, the operations of FIG. 4 may be employed by an entity to estimate the transmit power being used by an access point. The operations of FIG. 4 may be performed by an access point, a network entity, or some other suitable entity or entities.

As represented by block 402, at some point in time, a signal is received at an entity. In some aspects, this signal is indicative of the physical layer identifier being used by (or otherwise allocate to) an access point.

The signal may be received in various ways. For example, the entity may directly receive a signal (e.g., a reference signal) broadcast by the access point. As another example, the entity may receive the signal from another entity that directly received a signal broadcast by the access point. As yet another example, the entity may receive the signal from another entity that knows which physical layer identifier is allocated to the access point.

As represented by block 404, a physical layer identifier of the access point is determined based on the signal received at block 402. For example, in implementations where the received signal is a reference signal, the physical layer identifier used by the access point to encode the signal may be obtained by successfully decoding the received signals. As another example, in implementations where the received signal (e.g., a message) includes an indication of the physical layer identifier, the physical layer identifier may simply be read from the signal.

As discussed herein, a set of physical layer identifiers used by a network may comprise a first subset of physical layer identifiers that are allocated for mobility measurements and a second subset of physical layer identifiers that are not allocated for mobility measurements. Accordingly, in some aspects, the determination of the physical layer identifier may comprise determining whether the physical layer identifier of the access point is from a first set of physical layer identifiers that are allocated for mobility measurements or a second set of physical layer identifiers that are not allocated for mobility measurements.

As represented by block 406, a transmit power of the access point is determined based on the physical layer identifier determined at block 404. For example, if the physical layer identifier is one of those allocated for mobility measurements, an assumption may be made that the access point transmits at a relatively high level. Conversely, if the physical layer identifier is not one of those allocated for mobility measurements, an assumption may be made that the access point transmits at a relatively low level. Accordingly, in some aspects, the determination of the transmit power at block 406 may comprise determining whether the physical layer identifier of the access point is from a first set of physical layer identifiers associated with high transmit power or a second set of physical layer identifiers associated with low transmit power.

In some implementations, the designation of a low transmit power versus a high transmit power may be made relative to a defined threshold. For example, if the physical layer identifier is one of those allocated for mobility measurements, an assumption may be made that the access point transmits at a level that is above the threshold. Conversely, if the physical layer identifier is not one of those allocated for mobility measurements, an assumption may be made that the access point transmits at a level that is below the threshold. Accordingly, in some aspects, the determination of the transmit power at block 406 may comprise determining whether the transmit power is above or below a threshold transmit power level.

As represented by block 408, an action is invoked based on the transmit power determined at block 406. In some aspects, the invocation of the action comprises selecting a transmit power for another access point based on the determined transmit power. In some aspects, the invocation of the action comprises selecting a mobility parameter for another access point based on the determined transmit power.

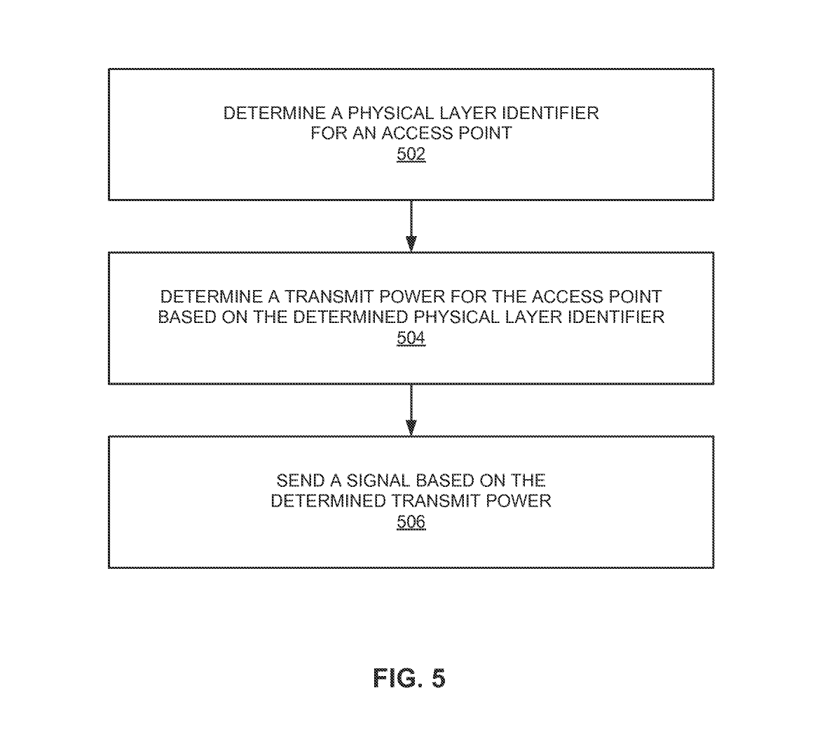

FIG. 5 illustrates another example of operations that may be performed in conjunction with determining transmit power based on a physical layer identifier. For example, the transmit power to be used by an access point may be selected based on the physical layer identifier being used by (or otherwise allocated for) the access point. The operations of FIG. 5 may be performed by an access point, a network entity, or some other suitable entity or entities.

As represented by block 502, at some point in time, a physical layer identifier for an access point is determined. This determination may involve, for example, selecting the physical layer identifier to be used by the access point, receiving an indication of the physical layer identifier to be used by the access point, negotiating with another entity to agree upon a physical layer identifier to be used by the access point, and so on.

As discussed herein, a set of physical layer identifiers used by a network may comprise a first subset of physical layer identifiers that are allocated for mobility measurements and a second subset of physical layer identifiers that are not allocated for mobility measurements. Accordingly, in some aspects, the determination of the physical layer identifier may comprise selecting between a physical layer identifier from a first set of physical layer identifiers that are allocated for mobility measurements or a physical layer identifier from a second set of physical layer identifiers that are not allocated for mobility measurements.

As represented by block 504, a transmit power for the access point is determined based on the physical layer identifier determined at block 502. For example, if the physical layer identifier is one of those allocated for mobility measurements, a relatively high transmit power may be selected for the access point. Conversely, if the physical layer identifier is not one of those allocated for mobility measurements, a relatively low transmit power may be selected for the access points. Accordingly, in some aspects, the determination of the transmit power at block 406 may comprise determining whether the physical layer identifier of the access point is from a first set of physical layer identifiers associated with high transmit power or a second set of physical layer identifiers associated with low transmit power. Also, in some aspects, the determination of the transmit power may comprise selecting between a transmit power associated with the high transmit power or a transmit power associated with the low transmit power.

In some implementations, the designation of a low transmit power versus a high transmit power may be made relative to a defined threshold. Accordingly, in some aspects, the determination of the transmit power may comprise selecting between a transmit power that is above a threshold or a transmit power that is below the threshold.

As represented by block 506, a signal is sent based on the transmit power determined at block 504. The form of this signal and the manner in which the signal is sent may depend, in some aspects, on the particular entity that is performing the operations of FIG. 5.

In an implementation where the access point performs the operations of FIG. 5 (e.g., the access point determines its own transmit power), the sending of the signal at block 306 may involve, for example, broadcasting a signal (e.g., a reference signal) at a transmit power that is calculated based on the transmit power determined at block 504. Accordingly, in some aspects, the sending of the signal may comprise transmitting a signal at a power level that is based on the determined transmit power. As another example, the sending of the signal at block 306 may involve sending (e.g., transmitting) a signal that comprises (e.g., includes) an indication of the transmit power determined at block 504.

In an implementation where another entity performs the operations of FIG. 5 (e.g., a network entity determines the access point's transmit power), the sending of the signal at block 306 may involve, for example, telling the access point what transmit power it should use. Accordingly, in some aspects, the sending of the signal may comprise sending an indication of the determined transmit power to the access point.

FIG. 6 illustrates several sample components (represented by corresponding blocks) that may be incorporated into an apparatus 602, an apparatus 604, and an apparatus 606 (e.g., corresponding to an access terminal, an access point, and a network entity, respectively) to perform physical layer identifier and transmit power determination operations as taught herein. It should be appreciated that these components may be implemented in different types of apparatuses in different implementations (e.g., in an application-specific integrated circuit (ASIC), in a system-on-a-chip (SoC), etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 602 and the apparatus 604 each include at least one wireless communication device (represented by the communication devices 608 and 614 (and the communication device 620 if the apparatus 604 is a relay)) for communicating with other nodes via at least one designated radio access technology. Each communication device 608 includes at least one transmitter (represented by the transmitter 610) for transmitting and encoding signals (e.g., messages, indications, information, and so on) and at least one receiver (represented by the receiver 612) for receiving and decoding signals (e.g., messages, indications, information, pilots, and so on). Similarly, each communication device 614 includes at least one transmitter (represented by the transmitter 616) for transmitting signals (e.g., messages, indications, information, pilots, and so on) and at least one receiver (represented by the receiver 618) for receiving signals (e.g., messages, indications, information, and so on). If the apparatus 604 is a relay access point, each communication device 620 may include at least one transmitter (represented by the transmitter 622) for transmitting signals (e.g., messages, indications, information, pilots, and so on) and at least one receiver (represented by the receiver 624) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 604 comprises a network listen module.

The apparatus 606 (and the apparatus 604 if it is not a relay access point) includes at least one communication device (represented by the communication device 626 and, optionally, 620) for communicating with other nodes. For example, the communication device 626 may comprise a network interface that is configured to communicate with one or more network entities via a wire-based or wireless backhaul. In some aspects, the communication device 626 may be implemented as a transceiver configured to support wire-based or wireless signal communication. This communication may involve, for example, sending and receiving: messages, parameters, or other types of information. Accordingly, in the example of FIG. 6, the communication device 626 is shown as comprising a transmitter 628 and a receiver 630. Similarly, if the apparatus 604 is not a relay access point, the communication device 620 may comprise a network interface that is configured to communicate with one or more network entities via a wire-based or wireless backhaul. As with the communication device 626, the communication device 620 is shown as comprising a transmitter 622 and a receiver 624.

The apparatuses 602, 604, and 606 also include other components that may be used in conjunction with physical layer identifier and transmit power determination operations as taught herein. The apparatus 602 includes a processing system 632 for providing functionality relating to, for example, communicating with an access point and for providing other processing functionality. The apparatus 604 includes a processing system 634 for providing functionality relating to, for example, physical layer identifier and transmit power determination as taught herein and for providing other processing functionality. The apparatus 606 includes a processing system 636 for providing functionality relating to, for example, physical layer identifier and transmit power determination as taught herein and for providing other processing functionality. The apparatuses 602, 604, and 606 include memory devices 638, 640, and 642 (e.g., each including a memory device), respectively, for maintaining information (e.g., information indicative of reserved resources, thresholds, parameters, and so on). In addition, the apparatuses 602, 604, and 606 include user interface devices 644, 646, and 648, respectively, for providing indications (e.g., audible and/or visual indications) to a user and/or for receiving user input (e.g., upon user actuation of a sensing device such a keypad, a touch screen, a microphone, and so on).

For convenience, the apparatus 602 is shown in FIG. 6 as including components that may be used in the various examples described herein. In practice, the illustrated blocks may have different functionality in different aspects. For example, functionality of the block 634 for supporting the implementation of FIG. 3 may be different as compared to functionality of the block 634 for supporting the implementation of FIG. 4.

The components of FIG. 6 may be implemented in various ways. In some implementations, the components of FIG. 6 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 608, 632, 638, and 644 may be implemented by processor and memory component(s) of the apparatus 602 (e.g., by execution of appropriate code and/or by appropriate configuration of processor components). Similarly, some or all of the functionality represented by blocks 614, 620, 634, 640, and 646 may be implemented by processor and memory component(s) of the apparatus 604 (e.g., by execution of appropriate code and/or by appropriate configuration of processor components). Also, some or all of the functionality represented by blocks 626, 636, 642, and 648 may be implemented by processor and memory component(s) of the apparatus 606 (e.g., by execution of appropriate code and/or by appropriate configuration of processor components).

As discussed above, the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with other types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

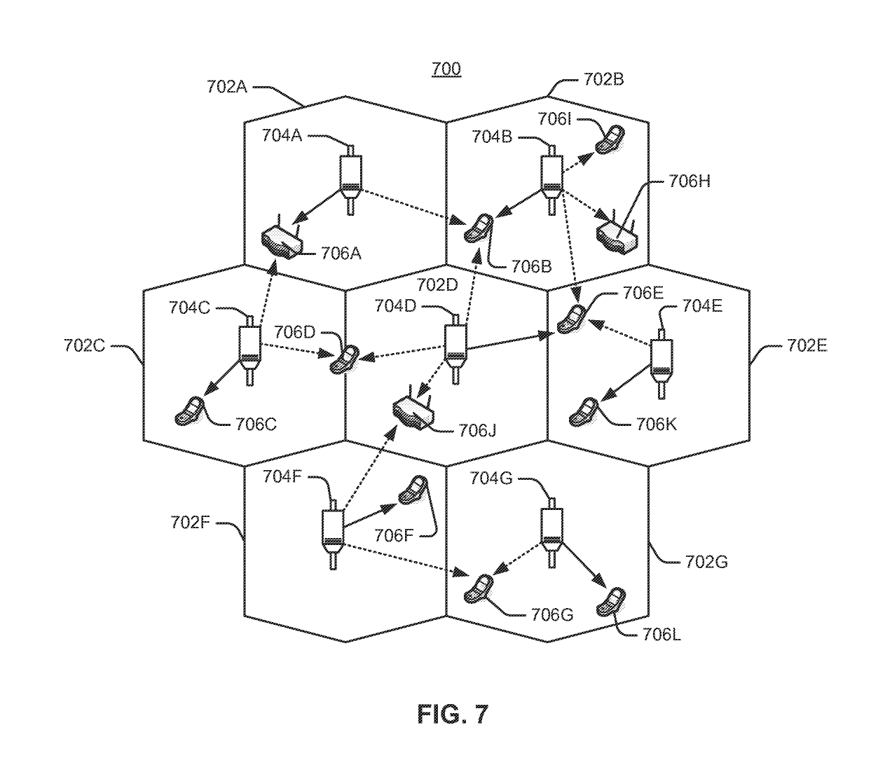

FIG. 7 illustrates a wireless communication system 700, configured to support a number of users, in which the teachings herein may be implemented. The system 700 provides communication for multiple cells 702, such as, for example, macro cells 702A-702G, with each cell being serviced by a corresponding access point 704 (e.g., access points 704A-704G). As shown in FIG. 7, access terminals 706 (e.g., access terminals 706A-706L) may be dispersed at various locations throughout the system over time. Each access terminal 706 may communicate with one or more access points 704 on a forward link (FL) and/or a reverse link (RL) at a given moment, depending upon whether the access terminal 706 is active and whether it is in soft handoff, for example. The wireless communication system 700 may provide service over a large geographic region. For example, macro cells 702A-702G may cover a few blocks in a neighborhood or several miles in a rural environment.

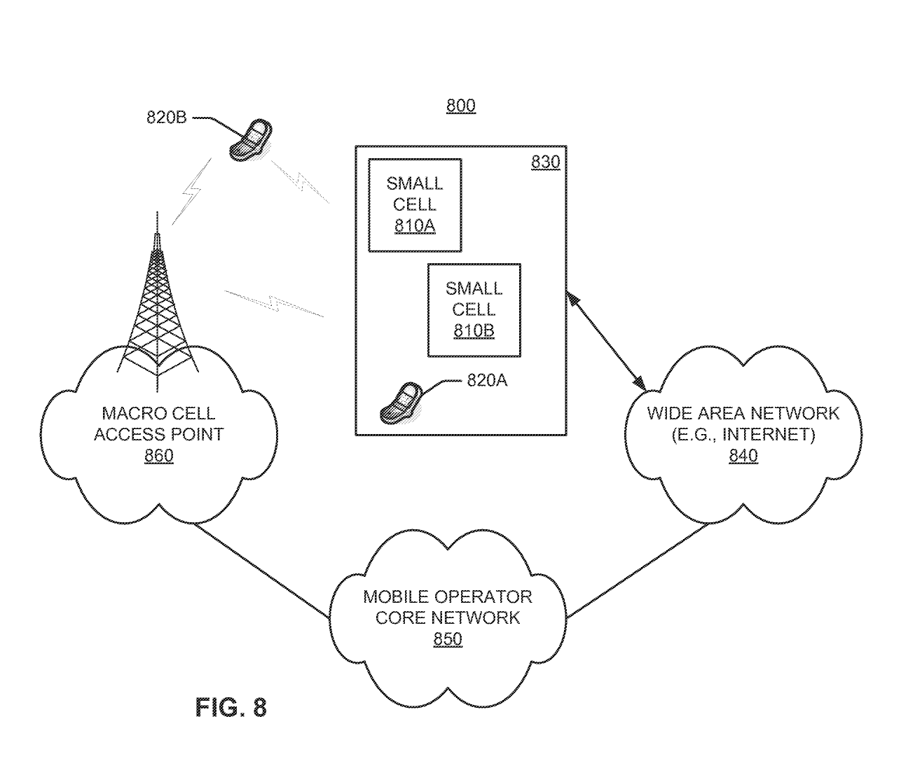

FIG. 8 illustrates an example of a communication system 800 where one or more small cells are deployed within a network environment. Specifically, the system 800 includes multiple small cells 810 (e.g., small cells 810A and 810B) installed in a relatively small scale network environment (e.g., in one or more user residences 830). Each small cell 810 may be coupled to a wide area network 840 (e.g., the Internet) and a mobile operator core network 850 via a DSL router, a cable modem, a wireless link, or other connectivity means (not shown). As will be discussed below, each small cell 810 may be configured to serve associated access terminals 820 (e.g., access terminal 820A) and, optionally, other (e.g., hybrid or alien) access terminals 820 (e.g., access terminal 820B). In other words, access to small cells 810 may be restricted whereby a given access terminal 820 may be served by a set of designated (e.g., home) small cell(s) 810 but may not be served by any non-designated small cells 810 (e.g., a neighbor's small cell 810).

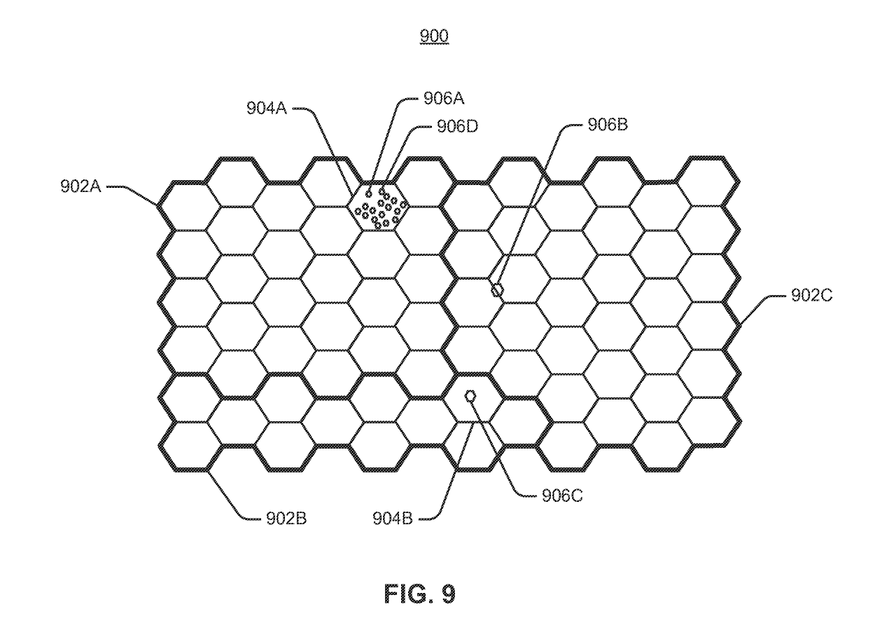

FIG. 9 illustrates an example of a coverage map 900 where several tracking areas 902 (or routing areas or location areas) are defined, each of which includes several macro coverage areas 904. Here, areas of coverage associated with tracking areas 902A, 902B, and 902C are delineated by the wide lines and the macro coverage areas 904 are represented by the larger hexagons. The tracking areas 902 also include femto coverage areas 906. In this example, each of the femto coverage areas 906 (e.g., femto coverage areas 906B and 906C) is depicted within one or more macro coverage areas 904 (e.g., macro coverage areas 904A and 904B). It should be appreciated, however, that some or all of a femto coverage area 906 might not lie within a macro coverage area 904. In practice, a large number of femto coverage areas 906 (e.g., femto coverage areas 906A and 906D) may be defined within a given tracking area 902 or macro coverage area 904. Also, one or more pico coverage areas (not shown) may be defined within a given tracking area 902 or macro coverage area 904.

Referring again to FIG. 8, the owner of a small cell 810 may subscribe to mobile service, such as, for example, 3G mobile service, offered through the mobile operator core network 850. In addition, an access terminal 820 may be capable of operating both in macro environments and in smaller scale (e.g., residential) network environments. In other words, depending on the current location of the access terminal 820, the access terminal 820 may be served by a macro cell access point 860 associated with the mobile operator core network 850 or by any one of a set of small cells 810 (e.g., the small cells 810A and 810B that reside within a corresponding user residence 830). For example, when a subscriber is outside his home, he is served by a standard macro access point (e.g., access point 860) and when the subscriber is at home, he is served by a small cell (e.g., small cell 810A). Here, a small cell 810 may be backward compatible with legacy access terminals 820.

A small cell 810 may be deployed on a single frequency or, in the alternative, on multiple frequencies. Depending on the particular configuration, the single frequency or one or more of the multiple frequencies may overlap with one or more frequencies used by a macro access point (e.g., access point 860).

In some aspects, an access terminal 820 may be configured to connect to a preferred small cell (e.g., the home small cell of the access terminal 820) whenever such connectivity is possible. For example, whenever the access terminal 820A is within the user's residence 830, it may be desired that the access terminal 820A communicate only with the home small cell 810A or 810B.

In some aspects, if the access terminal 820 operates within the macro cellular network 850 but is not residing on its most preferred network (e.g., as defined in a preferred roaming list), the access terminal 820 may continue to search for the most preferred network (e.g., the preferred small cell 810) using a better system reselection (BSR) procedure, which may involve a periodic scanning of available systems to determine whether better systems are currently available and subsequently acquire such preferred systems. The access terminal 820 may limit the search for specific band and channel. For example, one or more femto channels may be defined whereby all small cells (or all restricted small cells) in a region operate on the femto channel(s). The search for the most preferred system may be repeated periodically. Upon discovery of a preferred small cell 810, the access terminal 820 selects the small cell 810 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 810 that reside within the corresponding user residence 830). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., 911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

For convenience, the disclosure herein describes various functionality in the context of a small cell. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

FIG. 10 illustrates a wireless device 1010 (e.g., an access point) and a wireless device 1050 (e.g., an access terminal) of a sample MIMO system 1000. At the device 1010, traffic data for a number of data streams is provided from a data source 1012 to a transmit (TX) data processor 1014. Each data stream may then be transmitted over a respective transmit antenna.

The TX data processor 1014 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1030. A data memory 1032 may store program code, data, and other information used by the processor 1030 or other components of the device 1010.

The modulation symbols for all data streams are then provided to a TX MIMO processor 1020, which may further process the modulation symbols (e.g., for OFDM). The TX MIMO processor 1020 then provides N_{T} modulation symbol streams to N_{T} transceivers (XCVR) 1022A through 1022T. In some aspects, the TX MIMO processor 1020 applies beam-forming weights to the symbols of the data streams and to the antenna from which the symbol is being transmitted.

Each transceiver 1022 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1022A through 1022T are then transmitted from N_{T} antennas 1024A through 1024T, respectively.

At the device 1050, the transmitted modulated signals are received by N_{R} antennas 1052A through 1052R and the received signal from each antenna 1052 is provided to a respective transceiver (XCVR) 1054A through 1054R. Each transceiver 1054 conditions (e.g., filters, amplifies, and downconverts) a respective received signal, digitizes the conditioned signal to provide samples, and further processes the samples to provide a corresponding “received” symbol stream.

A receive (RX) data processor 1060 then receives and processes the N_{R} received symbol streams from N_{R} transceivers 1054 based on a particular receiver processing technique to provide N_{T} “detected” symbol streams. The RX data processor 1060 then demodulates, deinterleaves, and decodes each detected symbol stream to recover the traffic data for the data stream. The processing by the RX data processor 1060 is complementary to that performed by the TX MIMO processor 1020 and the TX data processor 1014 at the device 1010.

A processor 1070 periodically determines which pre-coding matrix to use (discussed below). The processor 1070 formulates a reverse link message comprising a matrix index portion and a rank value portion. A data memory 1072 may store program code, data, and other information used by the processor 1070 or other components of the device 1050.

The reverse link message may comprise various types of information regarding the communication link and/or the received data stream. The reverse link message is then processed by a TX data processor 1038, which also receives traffic data for a number of data streams from a data source 1036, modulated by a modulator 1080, conditioned by the transceivers 1054A through 1054R, and transmitted back to the device 1010.

At the device 1010, the modulated signals from the device 1050 are received by the antennas 1024, conditioned by the transceivers 1022, demodulated by a demodulator (DEMOD) 1040, and processed by a RX data processor 1042 to extract the reverse link message transmitted by the device 1050. The processor 1030 then determines which pre-coding matrix to use for determining the beam-forming weights then processes the extracted message.

FIG. 10 also illustrates that the communication components may include one or more components that perform timer control operations as taught herein. For example, identifier and/or transmit (ID/TX) control component 1090 may cooperate with the processor 1030 and/or other components of the device 1010 to determine a physical layer identifier and/or a transmit power to be used in conjunction with communication with another device (e.g., device 1050) as taught herein. It should be appreciated that for each device 1010 and 1050 the functionality of two or more of the described components may be provided by a single component. For example, a single processing component may provide the functionality of the ID/TX control component 1090 and the processor 1030.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

In view of the above, in some aspects a first apparatus for communication comprises: a communication device configured to receive a signal; and a processing system configured to determine a physical layer identifier of an access point based on the received signal, determine a transmit power of the access point based on the determined physical layer identifier, and invoke an action based on the determined transmit power.

In addition, in some aspects at least one of the following also may apply to the first apparatus for communication: the determination of the transmit power comprises determining whether the physical layer identifier of the access point is from a first set of physical layer identifiers associated with high transmit power or a second set of physical layer identifiers associated with low transmit power; the determination of the physical layer identifier comprises determining whether the physical layer identifier of the access point is from a first set of physical layer identifiers that are allocated for mobility measurements or a second set of physical layer identifiers that are not allocated for mobility measurements; the determination of the transmit power comprises determining whether the transmit power is above or below a threshold transmit power level; the invocation of the action comprises selecting a transmit power for another access point based on the determined transmit power; the invocation of the action comprises selecting a mobility parameter for another access point based on the determined transmit power; the access point comprises at least one of a small cell, a femto cell, a low-power cell, a Home NodeB (HNB), or a Home eNodeB (HeNB).

In view of the above, in some aspects a first method of communication comprises: receiving a signal; determining a physical layer identifier of an access point based on the received signal; determining a transmit power of the access point based on the determined physical layer identifier; and invoking an action based on the determined transmit power.

In addition, in some aspects at least one of the following also may apply to the first method of communication: the determination of the transmit power comprises determining whether the physical layer identifier of the access point is from a first set of physical layer identifiers associated with high transmit power or a second set of physical layer identifiers associated with low transmit power; the determination of the physical layer identifier comprises determining whether the physical layer identifier of the access point is from a first set of physical layer identifiers that are allocated for mobility measurements or a second set of physical layer identifiers that are not allocated for mobility measurements; the determination of the transmit power comprises determining whether the transmit power is above or below a threshold transmit power level; the invocation of the action comprises selecting a transmit power for another access point based on the determined transmit power; the invocation of the action comprises selecting a mobility parameter for another access point based on the determined transmit power; the access point comprises at least one of a small cell, a femto cell, a low-power cell, a Home NodeB (HNB), or a Home eNodeB (HeNB).

In view of the above, in some aspects a second apparatus for communication comprises: means for means for receiving a signal; means for determining a physical layer identifier of an access point based on the received signal; means for determining a transmit power of the access point based on the determined physical layer identifier; and means for invoking an action based on the determined transmit power.

In addition, in some aspects at least one of the following also may apply to the second apparatus for communication: the determination of the transmit power comprises determining whether the physical layer identifier of the access point is from a first set of physical layer identifiers associated with high transmit power or a second set of physical layer identifiers associated with low transmit power; the determination of the physical layer identifier comprises determining whether the physical layer identifier of the access point is from a first set of physical layer identifiers that are allocated for mobility measurements or a second set of physical layer identifiers that are not allocated for mobility measurements; the determination of the transmit power comprises determining whether the transmit power is above or below a threshold transmit power level; the invocation of the action comprises selecting a transmit power for another access point based on the determined transmit power; the invocation of the action comprises selecting a mobility parameter for another access point based on the determined transmit power; the access point comprises at least one of a small cell, a femto cell, a low-power cell, a Home NodeB (HNB), or a Home eNodeB (HeNB).

In view of the above, in some aspects a computer-program product comprises: computer-readable medium comprising code for causing a computer to: receive a signal; determine a physical layer identifier of an access point based on the received signal; determine a transmit power of the access point based on the determined physical layer identifier; and invoke an action based on the determined transmit power.

In addition, in some aspects at least one of the following also may apply to the computer-program product: the determination of the transmit power comprises determining whether the physical layer identifier of the access point is from a first set of physical layer identifiers associated with high transmit power or a second set of physical layer identifiers associated with low transmit power; the determination of the physical layer identifier comprises determining whether the physical layer identifier of the access point is from a first set of physical layer identifiers that are allocated for mobility measurements or a second set of physical layer identifiers that are not allocated for mobility measurements; the determination of the transmit power comprises determining whether the transmit power is above or below a threshold transmit power level; the invocation of the action comprises selecting a transmit power for another access point based on the determined transmit power; the invocation of the action comprises selecting a mobility parameter for another access point based on the determined transmit power; the access point comprises at least one of a small cell, a femto cell, a low-power cell, a Home NodeB (HNB), or a Home eNodeB (HeNB).

The functionality described herein (e.g., with regard to one or more of the accompanying figures) may correspond in some aspects to similarly designated “means for” functionality in the appended claims.

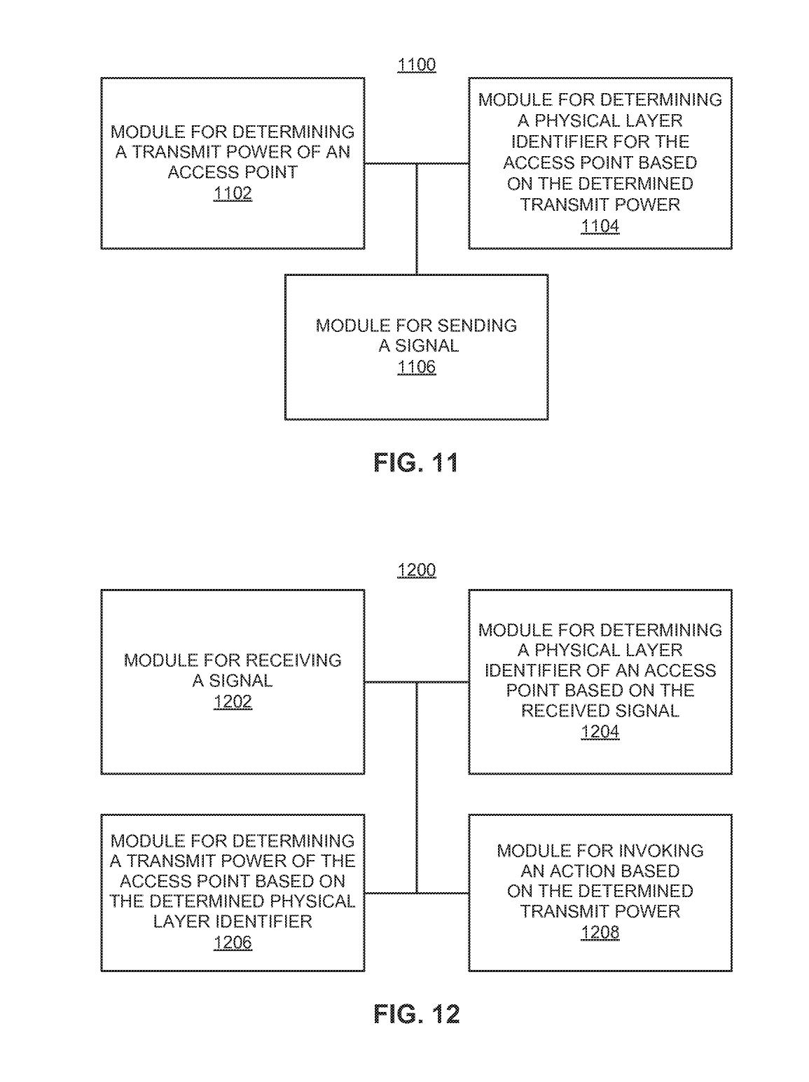

Referring to FIG. 11, an apparatus 1100 is represented as a series of interrelated functional modules. A module for determining a transmit power of an access point 1102 may correspond at least in some aspects to, for example, a processing system as discussed herein. A module for determining a physical layer identifier for the access point based on the determined transmit power 1104 may correspond at least in some aspects to, for example, a processing system as discussed herein. A module for sending a signal 1106 may correspond at least in some aspects to, for example, a communication device (e.g., a transmitter) as discussed herein.

Referring to FIG. 12, an apparatus 1200 is represented as a series of interrelated functional modules. A module for receiving a signal 1202 may correspond at least in some aspects to, for example, a communication device (e.g., a receiver) as discussed herein. A module for determining a physical layer identifier of an access point based on the received signal 1204 may correspond at least in some aspects to, for example, a processing system as discussed herein. A module for determining a transmit power of the access point based on the determined physical layer identifier 1206 may correspond at least in some aspects to, for example, a processing system as discussed herein. A module for invoking an action based on the determined transmit power 1208 may correspond at least in some aspects to, for example, a processing system as discussed herein.

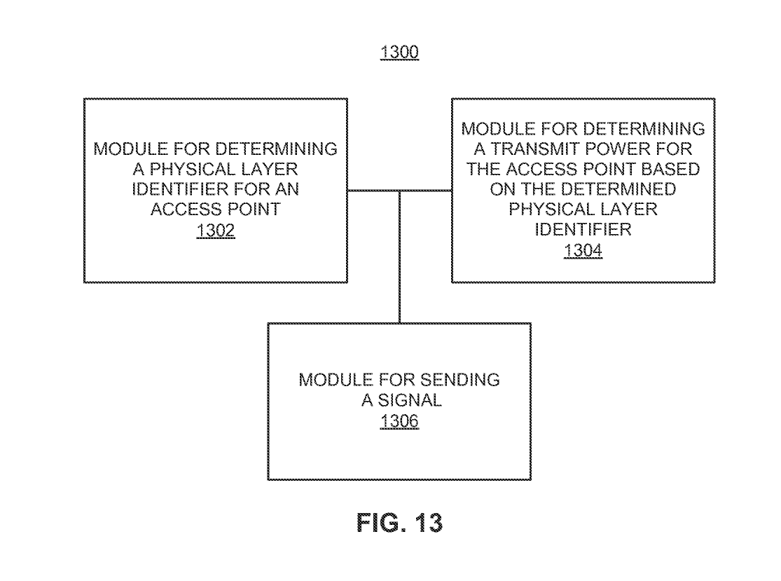

Referring to FIG. 13, an apparatus 1300 is represented as a series of interrelated functional modules. A module for determining a physical layer identifier for an access point 1302 may correspond at least in some aspects to, for example, a processing system as discussed herein. A module for determining a transmit power for the access point based on the determined physical layer identifier 1304 may correspond at least in some aspects to, for example, a processing system as discussed herein. A module for sending a signal 1306 may correspond at least in some aspects to, for example, a communication device (e.g., a transmitter) as discussed herein.

The functionality of the modules of FIGS. 11-13 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1200 may comprise a single device (e.g., components 1202-1208 comprising different sections of an ASIC). As another specific example, the apparatus 1200 may comprise several devices (e.g., the component 1202 comprising one ASIC and the components 1204, 1206, and 1208 comprising another ASIC). The functionality of these modules also may be implemented in some other manner as taught herein. In some aspects one or more of any dashed blocks in FIGS. 11-13 are optional.

In addition, the components and functions represented by FIGS. 11-13 as well as other components and functions described herein, may be implemented using any suitable means. Such means also may be implemented, at least in part, using corresponding structure as taught herein. For example, the components described above in conjunction with the “module for” components of FIGS. 11-13 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm operations described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of operations in any disclosed process is an example of a sample approach. Based upon design preferences, it is understood that the specific order or hierarchy of operations in the processes may be rearranged while remaining within the scope of the present disclosure. The accompanying method claims present elements of the various operations in a sample order, and are not meant to be limited to the specific order or hierarchy presented.

The operations of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more implementations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a processing system configured to determine a transmit power of an access point, and determine a physical layer identifier for the access point based on the determined transmit power; and
a communication device configured to send a signal comprising the determined physical layer identifier.

2. The apparatus of claim 1, wherein the determination of the physical layer identifier comprises:
comparing the determined transmit power to a threshold; and
selecting a physical layer identifier from a set of physical layer identifiers based on the comparison.

3. The apparatus of claim 1, wherein:
a set of physical layer identifiers comprises a first subset of physical layer identifiers that are allocated for mobility measurements and a second subset of physical layer identifiers that are not allocated for mobility measurements; and
the determination of the physical layer identifier comprises determining whether to select the physical layer identifier for the access point from the first subset of physical layer identifiers or the second subset of physical layer identifiers.

4. The apparatus of claim 1, wherein:
a set of physical layer identifiers comprises a first subset of physical layer identifiers associated with a high transmit power and a second subset of physical layer identifiers associated with a low transmit power; and
the determination of the physical layer identifier comprises determining whether to select the physical layer identifier for the access point from the first subset of physical layer identifiers or the second subset of physical layer identifiers.

5. The apparatus of claim 1, wherein:
a set of physical layer identifiers comprises a first subset of physical layer identifiers associated with a high transmit power and a second subset of physical layer identifiers associated with a low transmit power; and
the determination of the physical layer identifier comprises determining whether the transmit power of the access point corresponds to the high transmit power or the low transmit power, and determining, based on the determination of whether the transmit power of the access point corresponds to the high transmit power or the low transmit power, whether to select the physical layer identifier for the access point from the first subset of physical layer identifiers or the second subset of physical layer identifiers.

6. The apparatus of claim 1, wherein the sending of the signal comprises sending the determined physical layer identifier to the access point.

7. The apparatus of claim 1, wherein the sending of the signal comprises transmitting a signal that is encoded based on the determined physical layer identifier.

8. The apparatus of claim 1, wherein the access point comprises at least one of a small cell, a femto cell, a low-power cell, a Home NodeB (HNB), or a Home eNodeB (HeNB).

9. A method of communication, comprising:
determining a transmit power of an access point;
determining a physical layer identifier for the access point based on the determined transmit power; and
sending a signal comprising the determined physical layer identifier.

10. The method of claim 9, wherein the determination of the physical layer identifier comprises:
comparing the determined transmit power to a threshold; and
selecting a physical layer identifier from a set of physical layer identifiers based on the comparison.

11. The method of claim 9, wherein:
a set of physical layer identifiers comprises a first subset of physical layer identifiers that are allocated for mobility measurements and a second subset of physical layer identifiers that are not allocated for mobility measurements; and
the determination of the physical layer identifier comprises determining whether to select the physical layer identifier for the access point from the first subset of physical layer identifiers or the second subset of physical layer identifiers.

12. The method of claim 9, wherein:
a set of physical layer identifiers comprises a first subset of physical layer identifiers associated with a high transmit power and a second subset of physical layer identifiers associated with a low transmit power; and
the determination of the physical layer identifier comprises determining whether to select the physical layer identifier for the access point from the first subset of physical layer identifiers or the second subset of physical layer identifiers.

13. The method of claim 9, wherein:
a set of physical layer identifiers comprises a first subset of physical layer identifiers associated with a high transmit power and a second subset of physical layer identifiers associated with a low transmit power; and
the determination of the physical layer identifier comprises determining whether the transmit power of the access point corresponds to the high transmit power or the low transmit power, and determining, based on the determination of whether the transmit power of the access point corresponds to the high transmit power or the low transmit power, whether to select the physical layer identifier for the access point from the first subset of physical layer identifiers or the second subset of physical layer identifiers.

14. The method of claim 9, wherein the sending of the signal comprises sending the determined physical layer identifier to the access point.

15. The method of claim 9, wherein the sending of the signal comprises transmitting a signal that is encoded based on the determined physical layer identifier.

16. The method of claim 9, wherein the access point comprises at least one of a small cell, a femto cell, a low-power cell, a Home NodeB (HNB), or a Home eNodeB (HeNB).

17. An apparatus for communication, comprising:
means for determining a transmit power of an access point;
means for determining a physical layer identifier for the access point based on the determined transmit power; and
means for sending a signal comprising the determined physical layer identifier.

18. The apparatus of claim 17, wherein the determination of the physical layer identifier comprises:
comparing the determined transmit power to a threshold; and
selecting a physical layer identifier from a set of physical layer identifiers based on the comparison.

19. The apparatus of claim 17, wherein:
a set of physical layer identifiers comprises a first subset of physical layer identifiers that are allocated for mobility measurements and a second subset of physical layer identifiers that are not allocated for mobility measurements; and
the determination of the physical layer identifier comprises determining whether to select the physical layer identifier for the access point from the first subset of physical layer identifiers or the second subset of physical layer identifiers.

20. The apparatus of claim 17, wherein:
a set of physical layer identifiers comprises a first subset of physical layer identifiers associated with a high transmit power and a second subset of physical layer identifiers associated with a low transmit power; and
the determination of the physical layer identifier comprises determining whether to select the physical layer identifier for the access point from the first subset of physical layer identifiers or the second subset of physical layer identifiers.

21. A computer-program product, comprising:
computer-readable medium comprising code for causing a computer to:
determine a transmit power of an access point;
determine a physical layer identifier for the access point based on the determined transmit power; and
send a signal comprising the determined physical layer identifier.

22. The computer-program product of claim 21, wherein the determination of the physical layer identifier comprises:
comparing the determined transmit power to a threshold; and
selecting a physical layer identifier from a set of physical layer identifiers based on the comparison.

23. The computer-program product of claim 21, wherein:
a set of physical layer identifiers comprises a first subset of physical layer identifiers that are allocated for mobility measurements and a second subset of physical layer identifiers that are not allocated for mobility measurements; and
the determination of the physical layer identifier comprises determining whether to select the physical layer identifier for the access point from the first subset of physical layer identifiers or the second subset of physical layer identifiers.

24. The computer-program product of claim 21, wherein:
a set of physical layer identifiers comprises a first subset of physical layer identifiers associated with a high transmit power and a second subset of physical layer identifiers associated with a low transmit power; and
the determination of the physical layer identifier comprises determining whether to select the physical layer identifier for the access point from the first subset of physical layer identifiers or the second subset of physical layer identifiers.

25. An apparatus for communication, comprising:
a processing system configured to determine a physical layer identifier for an access point, and determine a transmit power for the access point based on the determined physical layer identifier; and
a communication device configured to send a signal based on the determined transmit power.

26. The apparatus of claim 25, wherein the determination of the transmit power comprises determining whether the physical layer identifier of the access point is from a first set of physical layer identifiers associated with high transmit power or a second set of physical layer identifiers associated with low transmit power.

27. The apparatus of claim 26, wherein the determination of the transmit power comprises selecting between a transmit power associated with the high transmit power or a transmit power associated with the low transmit power.

28. The apparatus of claim 25, wherein the determination of the transmit power comprises selecting between a transmit power that is above a threshold or a transmit power that is below the threshold.

29. The apparatus of claim 25, wherein the determination of the physical layer identifier comprises selecting between a physical layer identifier from a first set of physical layer identifiers that are allocated for mobility measurements or a physical layer identifier from a second set of physical layer identifiers that are not allocated for mobility measurements.

30. The apparatus of claim 25, wherein the sending of the signal comprises sending an indication of the determined transmit power to the access point.

31. The apparatus of claim 25, wherein the sending of the signal comprises transmitting a signal at a power level that is based on the determined transmit power.

32. The apparatus of claim 25, wherein the access point comprises at least one of a small cell, a femto cell, a low-power cell, a Home NodeB (HNB), or a Home eNodeB (HeNB).

33. A method of communication, comprising:
determining a physical layer identifier for an access point;
determining a transmit power for the access point based on the determined physical layer identifier; and
sending a signal based on the determined transmit power.

34. The method of claim 33, wherein the determination of the transmit power comprises determining whether the physical layer identifier of the access point is from a first set of physical layer identifiers associated with high transmit power or a second set of physical layer identifiers associated with low transmit power.

35. The method of claim 34, wherein the determination of the transmit power comprises selecting between a transmit power associated with the high transmit power or a transmit power associated with the low transmit power.

36. The method of claim 33, wherein the determination of the transmit power comprises selecting between a transmit power that is above a threshold or a transmit power that is below the threshold.

37. The method of claim 33, wherein the determination of the physical layer identifier comprises selecting between a physical layer identifier from a first set of physical layer identifiers that are allocated for mobility measurements or a physical layer identifier from a second set of physical layer identifiers that are not allocated for mobility measurements.

38. The method of claim 33, wherein the sending of the signal comprises sending an indication of the determined transmit power to the access point.

39. The method of claim 33, wherein the sending of the signal comprises transmitting a signal at a power level that is based on the determined transmit power.

40. The method of claim 33, wherein the access point comprises at least one of a small cell, a femto cell, a low-power cell, a Home NodeB (HNB), or a Home eNodeB (HeNB).

41. An apparatus for communication, comprising:
means for determining a physical layer identifier for an access point;
means for determining a transmit power for the access point based on the determined physical layer identifier; and
means for sending a signal based on the determined transmit power.

42. The apparatus of claim 41, wherein the determination of the transmit power comprises determining whether the physical layer identifier of the access point is from a first set of physical layer identifiers associated with high transmit power or a second set of physical layer identifiers associated with low transmit power.

43. The apparatus of claim 42, wherein the determination of the transmit power comprises selecting between a transmit power associated with the high transmit power or a transmit power associated with the low transmit power.

44. The apparatus of claim 41, wherein the determination of the physical layer identifier comprises selecting between a physical layer identifier from a first set of physical layer identifiers that are allocated for mobility measurements or a physical layer identifier from a second set of physical layer identifiers that are not allocated for mobility measurements.

45. A computer-program product, comprising:
computer-readable medium comprising code for causing a computer to:
determine a physical layer identifier for an access point;
determine a transmit power for the access point based on the determined physical layer identifier; and
send a signal based on the determined transmit power.

46. The computer-program product of claim 45, wherein the determination of the transmit power comprises determining whether the physical layer identifier of the access point is from a first set of physical layer identifiers associated with high transmit power or a second set of physical layer identifiers associated with low transmit power.

47. The computer-program product of claim 46, wherein the determination of the transmit power comprises selecting between a transmit power associated with the high transmit power or a transmit power associated with the low transmit power.

48. The computer-program product of claim 45, wherein the determination of the physical layer identifier comprises selecting between a physical layer identifier from a first set of physical layer identifiers that are allocated for mobility measurements or a physical layer identifier from a second set of physical layer identifiers that are not allocated for mobility measurements.

49. An apparatus for communication, comprising:
a communication device configured to receive a signal; and
a processing system configured to determine a physical layer identifier of an access point based on the received signal, determine a transmit power of the access point based on the determined physical layer identifier, and invoke an action based on the determined transmit power.

50. A method of communication, comprising:
receiving a signal;
determining a physical layer identifier of an access point based on the received signal;
determining a transmit power of the access point based on the determined physical layer identifier; and
invoking an action based on the determined transmit power.

51. An apparatus for communication, comprising:
means for receiving a signal;
means for determining a physical layer identifier of an access point based on the received signal;
means for determining a transmit power of the access point based on the determined physical layer identifier; and
means for invoking an action based on the determined transmit power.

52. A computer-program product, comprising:
computer-readable medium comprising code for causing a computer to:
receive a signal;
determine a physical layer identifier of an access point based on the received signal;
determine a transmit power of the access point based on the determined physical layer identifier; and
invoke an action based on the determined transmit power.
